(19) United States
(12) Patent Application Publication
(10) Pub. No.: US 2012/0003072 A1
(43) Pub. Date: Jan. 5, 2012

(54) DEVICE FOR GRIPPING AND HANDLING ELONGATED CYLINDRICAL BODIES, SUCH AS PIPES OR THE LIKE

(75) Inventor: Marco Laurini, Busseto (PR) (IT)

(73) Assignee: LAURINI OFFICINE MECCANICHE S.R.L., Busseto (PR) (IT)

(21) Appl. No.: 13/256,479

(22) PCT Filed: Mar. 15, 2010
(86) PCT No.: PCT/IB2010/051104

§ 371 Date: Sep. 14, 2011

(30) Foreign Application Priority Data
Mar. 16, 2009 (IT) MI2009A000401

(51) Int. Cl. B66C 1/44; B25J 15/00

(52) U.S. Cl. 414/746.7; 294/106; 294/198

(57) ABSTRACT

A device for gripping and handling elongated cylindrical bodies, such as pipes or sections of piping (T)1 includes a supporting structure (2) with gripping members mounted on the supporting structure (2) designed to hold the pipe in at least two gripping points along the longitudinal axis of the pipe, the gripping members including at least one fixed portion (5) and at least one movable gripping element hinged to the fixed portion and subject to the action of elements for bringing it from a closed position wherein the device holds the pipe (T) into an open position wherein the device releases the pipe (T), elements being provided on at least the fixed portion (5) or the movable gripping element that enable the rotation of the pipe (T) while the movable gripping element is in the closed position.

The present invention relates to a device for gripping and handling elongated cylindrical bodies, such as pipes or sections of piping, and particularly pipes with large dimensions, such as those used in the construction of oil pipelines, gas pipelines or the like.

In detail, the device according to the invention is capable of holding a pipe or section of piping and rotating it around its longitudinal axis in order to bring it into a required angular position, then releasing it so that it rests on the ground in said required angular position.

More in particular, as mentioned previously, the invention relates to the sector of machinery used for the installation of piping such as for oil pipelines, gas pipelines or the like.

These pipelines are generally constructed directly on site by welding together different sections of piping that are subsequently laid underground, arranging the pipeline at the bottom of trenches and then covering it to protect the piping.

All these pipeline construction and installation operations necessitate the handling of these particularly heavy and bulky piping elements, for which specific machines, called pipe layers, are used.

Each section of piping is made starting from a metal sheet that is first rolled to lend it a circular profile, then welded in the longitudinal direction, parallel to the axis of the piping.

To avoid weakening the pipeline and ensure an adequate mechanical strength, said longitudinal weldings in two adjacent sections of piping must always be staggered by a few degrees, i.e. they must never be aligned with one another. That is why, when sections of piping are collected from a stack or from a truck and placed alongside the trench in order to join them together, it is necessary for them to be laid on the ground in a given angular position in relation to the adjacent piping.

Earthmoving machines such as diggers, or suitable cranes are currently used in the handling of these sections of piping, fitting the machines with a plurality of belts or slings connected to the movable arm that are wrapped around the piping so that it can be lifted and subsequently laid on the ground.

Although they are simple and effective, these handling systems carry several disadvantages during the procedure involved in the positioning of sections of piping along the trenches.

In fact, these sections of piping are generally collected from a stack or from a truck and wrapped with the belt or slings in a more or less random manner.

Subsequently, in order to place single sections of piping alongside the trench in the required angular position in relation to that of the adjacent pipe (for the reasons explained above), it becomes necessary to loosen the belts used to support the piping and to complete a series of manoeuvres that requires a certain ability on the part of the operator using the pipe-layer machine on the one hand, while on the other hand it entails a considerable risk to the operators on the ground, who have to work close to these suspended loads that weigh tens of tonnes.

All these positioning operations also take up a certain amount of time that gives rise, considering the enormous quantity of sections of piping that have to be placed in position in order to install a pipeline, to a marked increase in the time it takes to complete the works.

In this setting, the object of the present invention is a device for gripping and handling elongated cylindrical bodies, such as pipes or sections of piping, that overcomes the above-described drawbacks of the known art.

In particular, one object of the invention is a device for gripping and handling elongated cylindrical bodies, such as pipes or sections of piping, that enables said pipe or section of piping to be automatically gripped and rotated around its longitudinal axis in order to bring it into the required angular position, then released in order to rest it on the ground, without resorting to any use of operators working in the vicinity of the suspended loads.

Another object of the present invention is a device for gripping and handling elongated cylindrical bodies, such as pipes or sections of piping, that enables a considerable reduction in the time it takes to install and complete a pipeline, such as an oil or gas pipeline or the like.

The above-stated objects are substantially achieved by a device for gripping and handling elongated cylindrical bodies, such as pipes or sections of piping, comprising a supporting structure with means for its assembly on an earthmoving machine, with gripping means installed on said supporting structure designed to hold the pipe in at least two gripping points along the longitudinal axis of said piping, said gripping means comprising at least one fixed portion and at least one movable gripping element that is hinged to said fixed portion and subject to the action of means for bringing it from a closed position wherein the device holds the pipe so that it can be lifted and handled to an open position wherein the device releases the pipe ready for its installation, means being provided at least on said fixed portion or on said movable gripping element that are designed to enable the rotation of said pipe while said movable gripping element is in the closed position and the device is holding the pipe.

In detail, said means designed to enable the rotation of the pipe inside the gripping device consist of a plurality of rollers, at least one of which is motorised, hinged to said fixed portion or to said movable gripping element, said rollers being arranged with their own axis of rotation parallel to the longitudinal axis of the pipe and presenting a profile that extends beyond the shape of said fixed portion and of said movable gripping element so as to come into contact with the outer surface of the pipe when the latter is held inside the gripping device and so as to be able to turn the pipe into the required angular position.

Said gripping means preferably comprise at least one pair of clamps installed on the supporting structure, said clamps comprising a fixed portion and at least one jaw, hinged to said fixed portion and subject to the action of means that bring it from a closed position wherein the device holds the pipe so that it can be lifted and handled into an open position wherein the device releases the pipe ready for installation.

Even more preferably, the invention involves said clamps comprising a pair of jaws hinged to said fixed portion and subject to the action of means that bring them from a closed position wherein the device holds the pipe so that it can be lifted and handled into an open position wherein the device releases the pipe ready for installation.

A non-limiting example of the present invention is now described with reference to the attached figures, wherein:

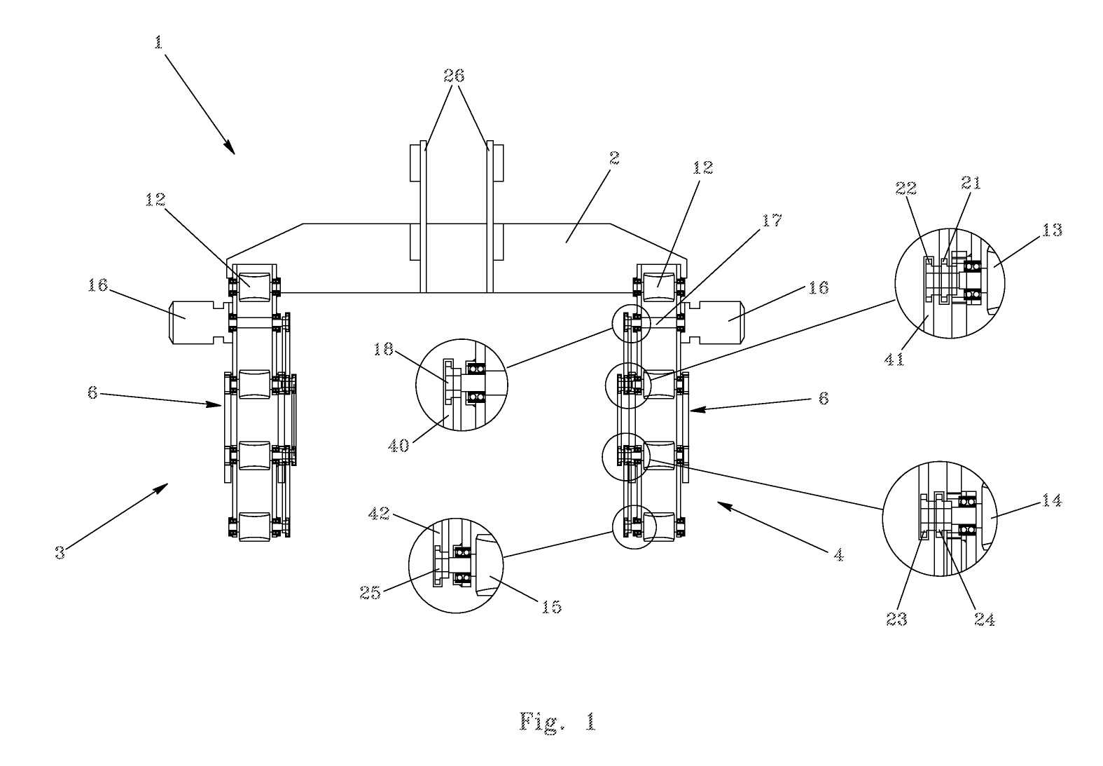

FIG. 1 is a side view of the gripping device according to the invention;

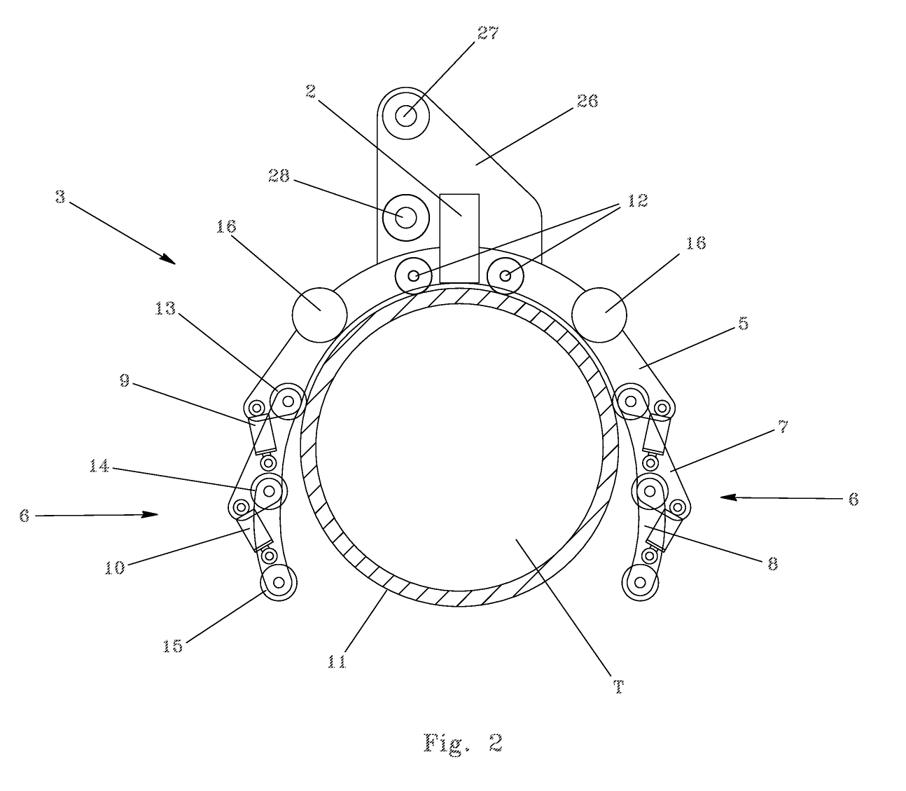

FIG. 2 is a front view of the gripping device according to the invention in the open position;

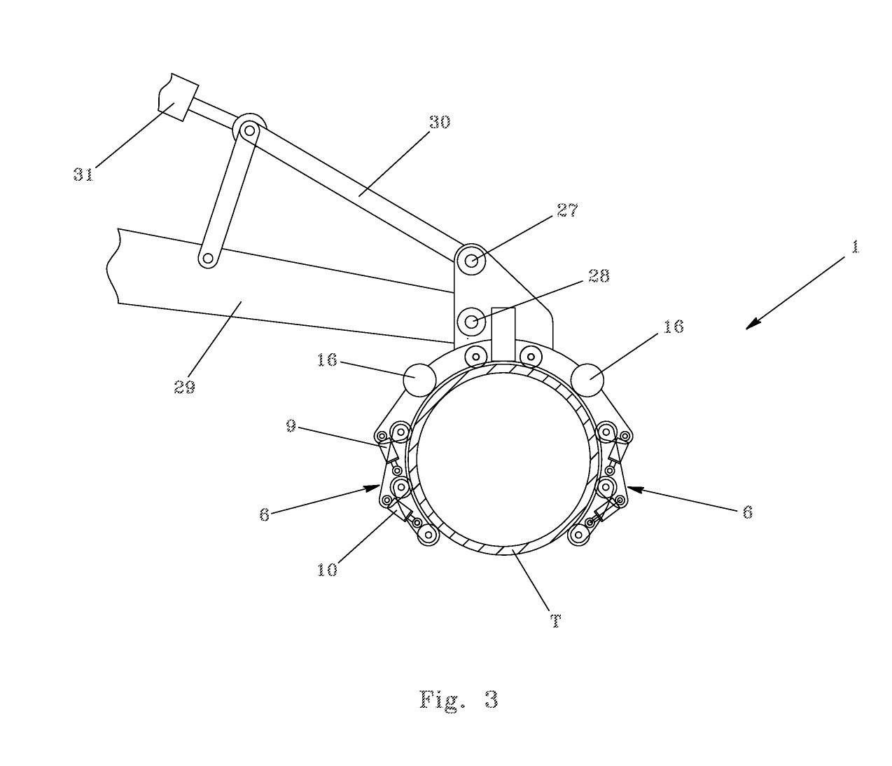

FIG. 3 is a front view of the gripping device assembled on the arm of a digger, in its closed position and holding a pipe;

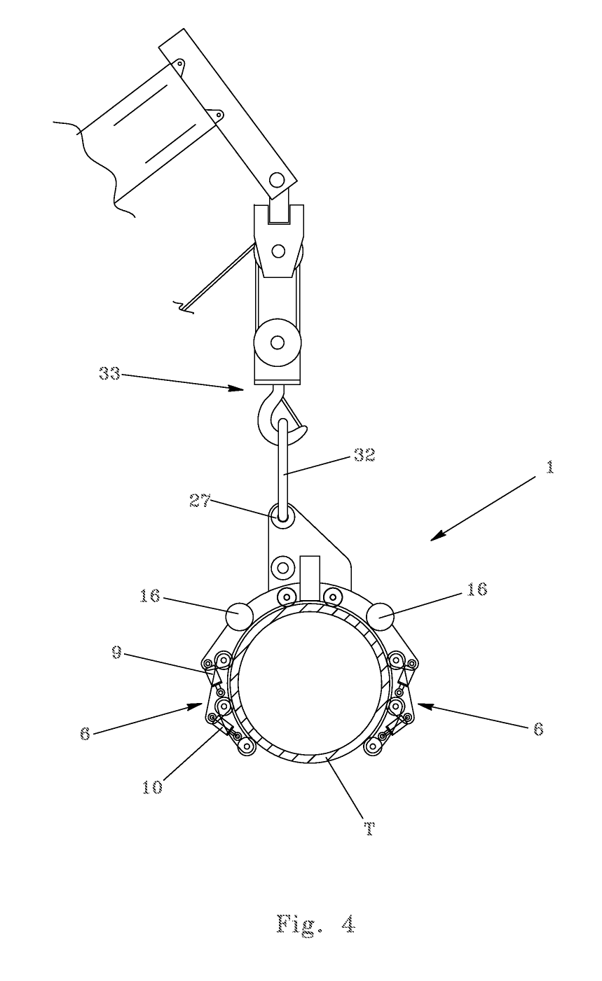

FIG. 4 is a front view of the gripping device assembled on the arm of a crane, in its closed position and holding a pipe.

With reference to FIGS. 1 and 2, the gripping and handling device, indicated globally by the numeral 1, comprises a supporting structure on which gripping means are installed that are designed to hold the pipe or section of piping at least in two gripping points along the longitudinal axis of said pipe.

Said gripping points have a suitable space between them so that the device can provide a balanced support for the pipe while it is being handled.

In fact, from the moment of its collection to its subsequent placement on the ground, and throughout the handling procedure, the pipe remains in a substantially horizontal position.

In detail, said gripping means consist of at least one pair of clamps 3 and 4, attached to the supporting structure, e.g. at the end of a cross member 2, as shown in the figure.

Said clamps in turn comprise at least one fixed portion consisting of an arched element 5 to which at least one movable gripping element consisting of a jaw is hinged.

Preferably, according to the invention, there is a pair of movable jaws 6 hinged to the ends of the arched element 5.

Said jaws 6 may be made of a single rigid element or, preferably, they may comprise two sectors 7 and 8, that are hinged to one another.

In particular, one end of the first sector 7 is hinged directly to one end of the arch 5, while the second sector 8 is hinged to the other end of the sector 7 so as to globally form an anthropomorphic structure.

Each sector of the jaw is subject to the action of oil-hydraulic actuators, or similar means, that enable the displacement of the jaw from an open position wherein it can be placed around a pipe T, to a closed position wherein it is locked around the pipe T so that the pipe can be lifted and handled.

In detail, the first actuator 9 that operates the first sector 7 is hinged at one end to the arch 5 and at the opposite end to said sector 7, while a second actuator 10, that operates the second sector 8, is hinged at one end to said first sector 7, and at the other end to said second sector 8.

A plurality of rollers are hinged at least to the fixed portion 5, or to the jaws 6 of the clamps 3 and 4, said rollers being arranged with their axis of rotation parallel to the longitudinal axis of the pipe and so that their profile extends beyond the shape of said fixed portion 5 or said jaws 6, so that they can come into contact with the outer surface 11 of the pipe T, when the pipe is being held by the clamps.

The number and size of said rollers may vary, depending on the dimensions (i.e. external diameter) and weight of the pipe or section of piping being handled.

According to the invention, at least one of said rollers is motorised so that it can entrain the pipe or section of piping in rotation when the latter is held in the clamps and all the rollers are in contact with the outer surface thereof.

In the example shown in the figures, there is a pair of rollers 12 hinged to the central part of the arch 5. Said rollers 12 are preferably installed so that they rotate idly on said arch 5, i.e. they are free to turn in contact with the pipe T.

The pairs of rollers 13, 14 and 15, are hinged instead to the sectors 7 and 8, of the jaws 6 and they are operated by a pair of motors 16, that are preferably hydraulic or electric motors.

The motion from the motor 16 is carried to the various rollers by means of a flexible transmission system such as belts or chains wrapped around pulleys or gear wheels.

In detail, the motor 16 is connected to a shaft 17 on which the first pulley 18 is mounted that, by means of a belt or chain 40, induces the rotation of a second pulley 21.

Said pulley 21 is connected to the roller 13 that is hinged in line with the joint between the end of the arch 5 and the first sector 7 of the jaw 6.

By means of a belt 41, the third pulley 22, coaxial to the pulley 21, transfers the motion to another pair of pulleys 23 and 24, connected to the roller 14, that is hinged in line with the joint between the first sector 7 and the second sector 8 of the jaw 6.

The pulley 23 drives the roller 14, while the pulley 24 transfers the motion, by means of a belt 42, to a sixth pulley 25 connected to the roller 15.

Said rollers 12, 13, 14 and 15 preferably consist of a core made of metal or a similar material, coated with a layer of rubber or plastic material that guarantees a sufficient friction to entrain the pipe T in rotation.

In order to connect the gripping device to the pipe-laying machine, there is a flange 26 at the midline of the cross member 2, in which there are two holes 27 and 28.

If the device 1 is assembled on an earthmoving machine, such as a digger or the like, the end of the digger arm 29 is hinged inside the hole 27 in the flange 26, while the connecting rod 30 connected to the oil-hydraulic actuator 31 is hinged inside the hole 28 (FIG. 3).

In this configuration, the hydraulic motors 16, and the actuators 9 and 10 that drive the jaws 6, are powered by the hydraulic pump on board the digger and can consequently be controlled directly by the machine operator.

On the other hand, in order to use the device 1 with a crane, e.g. with a pipe-laying crane, it is only necessary to insert a tackle 32 in the hole 27 in the flange 26, in order to be able to attach the device 1 to the crane hook 33 (FIG. 4).

In this case, the supply of oil under pressure for the actuators 9 and 10, and for the motors 16, or the electric power supply if electric motors are used, is provided by a power unit, not shown in the figure, that can be installed directly on board, e.g. on the cross member 2.

Radio-controlled remote means are used to control the power unit and actuators, which can be managed by the operator handling the pipe-laying machine, or by another operator on the ground.

The device functions as described below.

The operator of the machine, be it a digger or a crane, brings the device 1 into line with the pipe or section of piping T to collect from a stack or from a truck and, having already placed the jaws 6 in their open position, he lowers the device 1 until the rollers 12 installed on the arch 5 are substantially in contact with the surface of the pipe T (FIG. 2).

Then he uses the actuators 9 and 10 to close the jaws 6 around the pipe T, bringing the rollers 13, 14 and 15 into contact with the outer surface 11 of said pipe T so that it can be lifted and handled (FIGS. 3 and 4).

When the section of piping T has to be laid alongside the trench so that it can be attached to another section already deposited on the ground, depending on the position of the longitudinal welding on said section already deposited on the ground, the operator uses the hydraulic motors 16 to make the pairs of rollers 13, 14 and 15 rotate.

Thanks to the friction between the outer surface 11 of the pipe T and the rubber coating on said rollers, the latter entrain the pipe T in rotation in order to arrange it in the required angular position.

In particular, when the pipe is laid on the ground, it is essential for its longitudinal welding to be staggered at a certain angle with respect to that of the adjacent section of pipe previously positioned on the ground, as demanded by the construction standards for this type of pipeline.

Once this required angular position has been reached, it is only necessary to lower the device 1 until the pipe rests on the ground, and then to operate the actuators 9 and 10 again to open the jaws 6 and thus release the pipe.

Thanks to the present invention, it is consequently possible to produce a device that enables the gripping, handling and placement of a pipe or section of piping of the type used for the construction of oil pipelines, gas pipelines or the like, without the aid of personnel on the ground to facilitate the operation, and ore importantly with a considerable time saving by comparison with the known art.

The device for gripping and handling elongated cylindrical bodies, such as pipes or sections of piping, as described above, may undergo numerous modifications and variants, all coming within the scope of the inventive concept. In addition, all the component parts may be replaced by other technically equivalent elements.

1. A device for gripping and handling elongated cylindrical bodies, such as pipes or sections of piping (T), comprising a supporting structure (2) with means (26) for its assembly on an earthmoving machine, with gripping means installed on said supporting structure (2) that are designed to hold the pipe in at least two gripping points along the longitudinal axis of said pipe, said gripping means comprising at least one fixed portion (5) and at least one movable gripping element hinged to said fixed portion and subject to the action of means for bringing it from a closed position wherein the device holds the pipe (T) so that it can be lifted and handled into an open position wherein the device releases the pipe (T) ready for installation, means being provided at least on said fixed portion (5) or else on said movable gripping element that are designed to enable the rotation of said pipe (T), while said movable gripping element is in the closed position and the device is holding the pipe (T).

2. A device according to claim 1, characterised in that said means designed to enable the rotation of the pipe (T) while it is inside the gripping device (1) consist of a plurality of rollers hinged to said at least one fixed portion (5) and to said at least one movable gripping element (6), said rollers being arranged with their axis of rotation parallel to the longitudinal axis of the pipe, and with a profile that extends beyond the shape of said fixed portion (5) and said movable gripping element (6) so as to come into contact with the outer surface (11) of the pipe (T) when the latter is held inside the gripping device.

3. A gripping device according to claim 2, characterised in that at least one of said rollers is a motorised roller connected to a motor (16) for entraining the pipe (T) in rotation when it is being held in the gripping device.

4. A device according to claim 3, characterised in that said at least one motorised roller is connected to the motor (16) by flexible transmission means such as a belt or a chain installed on a pair of pulleys or pinions coaxially and integrally connected to said motor and to said at least one motorised roller.

5. A device according to claim 4, characterised in that said motor (16) is a hydraulic motor.

6. A device according to claim 3, characterised in that said gripping means comprise at least one pair of clamps (3, 4), installed on said supporting structure (2), said clamps comprising a fixed portion (5) and at least one jaw (6), hinged to said fixed portion (5) and subject to the action of drive means (9, 10) that bring it from a closed position wherein the device holds the pipe (T) so that it can be lifted and handled into an open position wherein the device releases the pipe (T) ready for installation.

7. A device according to claim 6, characterised in that it includes a pair of jaws (6) hinged to said fixed portion (5).

8. A device according to claim 6, characterised in that each of said jaws (6) is composed of two sectors (7, 8), said first sector (7) being hinged at a first end to the fixed portion (5) and said second sector (8) being hinged to the other end of said first sector (7).

9. A device according to claim 6, characterised in that said means for moving said jaws (6) are two hydraulic actuators (9, 10), the actuator (9), which moves the sector (7), being connected at one end to the element (5) and at the opposite end to said sector (7), and the actuator (10), which moves the sector (8), being connected at one end to the first sector (7) and at the opposite end to said second sector (8).

10. A device according to claim 7, characterised in that it includes at least one motorised roller installed on each jaw (6), a pair of motors (16) being installed on the fixed portion (5).

11. A device according to claim 10, characterised in that there are at least three motorised rollers (13, 14, 15) on each jaw (6).

12. A device according to claim 11, characterised in that said motorised rollers (13, 14, 15) are connected to one another by flexible transmission means such as belts or chains (41, 42) installed on pulleys or pinions coaxially and integrally connected to said motorised rollers.

13. A device according to claim 1, characterised in that said means (26) for assembling said device on an earthmoving machine, crane or the like comprise a flange (26) with two seats (27, 28).

14. A device according to claim 1, characterised in that a power unit is installed on the supporting structure (2) to deliver oil under pressure to the motors (16) and to the actuators (9, 10).

15. A device according to claim 1, characterised in that said gripping means comprise at least one pair of clamps (3, 4), installed on said supporting structure (2), said clamps comprising a fixed portion (5) and at least one jaw (6), hinged to said fixed portion (5) and subject to the action of drive means (9, 10) that bring it from a closed position wherein the device holds the pipe (T) so that it can be lifted and handled into an open position wherein the device releases the pipe (T) ready for installation.

16. A device according to claim 15, characterised in that it includes a pair of jaws (6) hinged to said fixed portion (5).

17. A device according to claim 15, characterised in that each of said jaws (6) is composed of two sectors (7, 8), said first sector (7) being hinged at a first end to the fixed portion (5) and said second sector (8) being hinged to the other end of said first sector (7).

18. A device according to claim 15, characterised in that said means for moving said jaws (6) are two hydraulic actuators (9, 10), the actuator (9), which moves the sector (7), being connected at one end to the element (5) and at the opposite end to said sector (7), and the actuator (10), which moves the sector (8), being connected at one end to the first sector (7) and at the opposite end to said second sector (8).

19. A device according to claim 7, characterised in that each of said jaws (6) is composed of two sectors (7, 8), said first sector (7) being hinged at a first end to the fixed portion (5) and said second sector (8) being hinged to the other end of said first sector (7).

20. A device according to claim 7, characterised in that said means for moving said jaws (6) are two hydraulic actuators (9, 10), the actuator (9), which moves the sector (7), being connected at one end to the element (5) and at the opposite end to said sector (7), and the actuator (10), which moves the sector (8), being connected at one end to the first sector (7) and at the opposite end to said second sector (8).
